(19) United States
(12) Patent Application Publication
(10) Pub. No.: US 2005/0174769 A1
(43) Pub. Date: Aug. 11, 2005

(54) LED light bulb and its application in a desk lamp

(76) Inventors: Gao Yong, Guangdong (CN); Ya Wang, Guangdong (CN)

Correspondence Address: ADE & COMPANY, 1700-360 MAIN STREET, WINNIPEG, MB, R3C3Z3, CA

(21) Appl. No.: 11/007,625

(22) Filed: Dec. 9, 2004

(30) Foreign Application Priority Data
Dec. 10, 2003 (CN) 03223677.8

(51) Int. Cl. F21V 21/00

(52) U.S. Cl. 362/235; 362/249; 362/800

(57) ABSTRACT

An LED light bulb includes a screw base, a shell formed by two halves of hemispherical shells connecting tightly in the middle and a number of LEDs distributed spherical symmetrically on a curved flexible PCB inside an inner front of the shell, where the LEDs are series or parallel connected and arranged, when working, to emit light evenly in all directions. The LED light bulb can be used in a desk lamp.

This invention involves an innovated LED light bulb, specifically, a bulb with LED units distributed symmetrically on a curved PCB inside its shell, and a desk lamp using the bulb.

### BACKGROUND OF THE INVENTION

Traditional illumination lights such as the incandescent light bulbs and the fluorescent lights, normally working under a voltage of 110V or 220V, though bright enough, suffer drawbacks like poor power efficiency, short product life, and a sometimes dazzling brightness. The LEDs, on the contrary, work under a low DC voltage with very low power waste as well as a long product life. As a result, LED light bulbs have been developed and put into practical use. However, the customary practice in the industry of arranging LED units on a flat plane in matrix or other forms brings a new problem. Because an LED emits light with high convergence, a group of LEDs arranged on a flat plain facing the same direction causes the narrow space centered along this direction to be illuminated far in excess of requirement and areas distant from it to be under-illuminated. When used as a lamp, this unevenness in illumination may dazzle the eye and lead to uncomfortableness.

### SUMMARY OF THE INVENTION

It is one object of the invention to provide an improved LED light bulb.

According to one aspect of the invention there is provided an LED light bulb comprising:
a screw base;
a shell formed by two halves of hemispherical shells connecting tightly in the middle;
and a number of LEDs distributed spherical symmetrically on a curved flexible PCB inside an inner front of the shell;
the LEDs being series or parallel connected and arranged, when working, to emit light evenly in all directions.

The solution to the problems of current LED light bulbs is a replacement of the flat plain on which LEDS are placed with an innovatively designed frame of curving, stellate blades. Closely attached to the frame is a flexible PCB, on which the soldered LEDs are distributed evenly and symmetrically, so that they head and beam towards a wide range of directions.

A built-in AD/DC converter inside the bulb shell converts alternating current to direct current that the LEDs work on. An electronic dimmer is also included inside the shell to adjust light brightness. The manual brightness modulating part of the dimmer is set on the surface of the bulb shell. Optionally, a negative oxygen ion generator can be installed inside the shell to send out negative oxygen ions through one or more small round openings on the surface of the shell when the light is on.

A desk lamp, adopting the LED light bulb, features a lamp fixture and a lamp holder, to which the LED light bulb is connected at its screw base. Alternatively, the AD/DC converter and the electronic dimmer can be placed inside the base of the lamp.

As such, the innovated eye-friendly LED light bulb enjoys an even and a large area illumination while inheriting its predecessors' advantages of low power waste and durability.

### BRIEF DESCRIPTION OF THE DRAWINGS

One embodiment of the invention will now be described in conjunction with the accompanying drawings in which:

FIG. 1 is a Schematic cross-sectional drawing of a first example of the sphered LED modular bulb according to the present invention.

FIG. 2 is an Elevation of the sphered LED modular bulb of FIG. 1.

FIG. 3 is an isometric view of the bulb of FIG. 1.

FIG. 4 is an exploded view of the bulb of FIG. 1.

FIG. 5 is a Schematic cross-sectional drawing of a second example of the sphered LED modular bulb according to the present invention.

FIG. 6 is an Elevation of the sphered LED modular bulb of FIG. 5.

FIG. 7 is an exploded view of the bulb of FIG. 5.

In the drawings like characters of reference indicate corresponding parts in the different figures.

### DETAILED DESCRIPTION

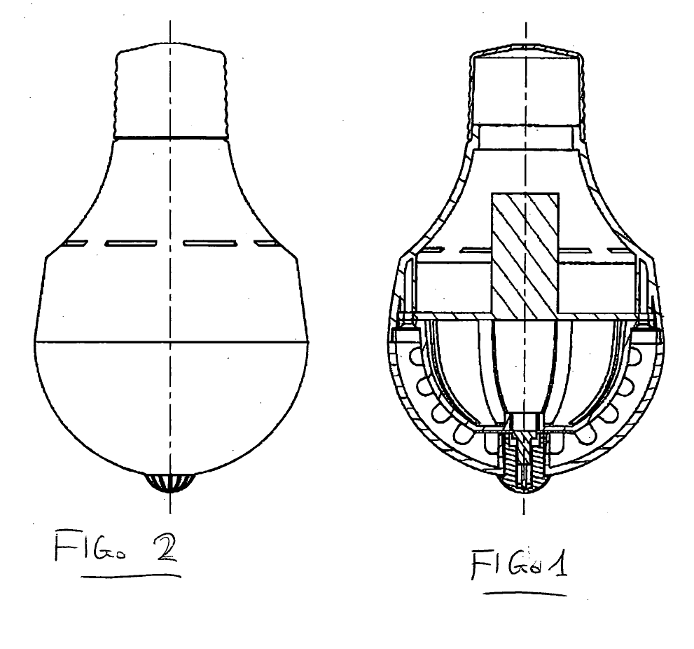

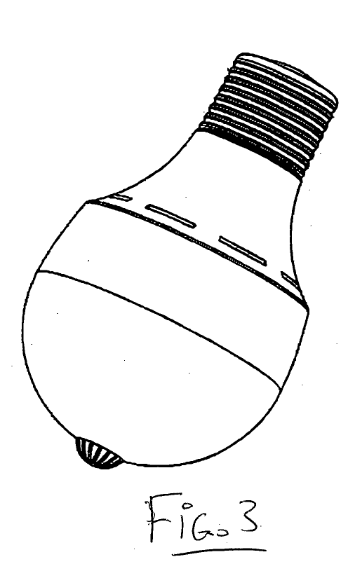

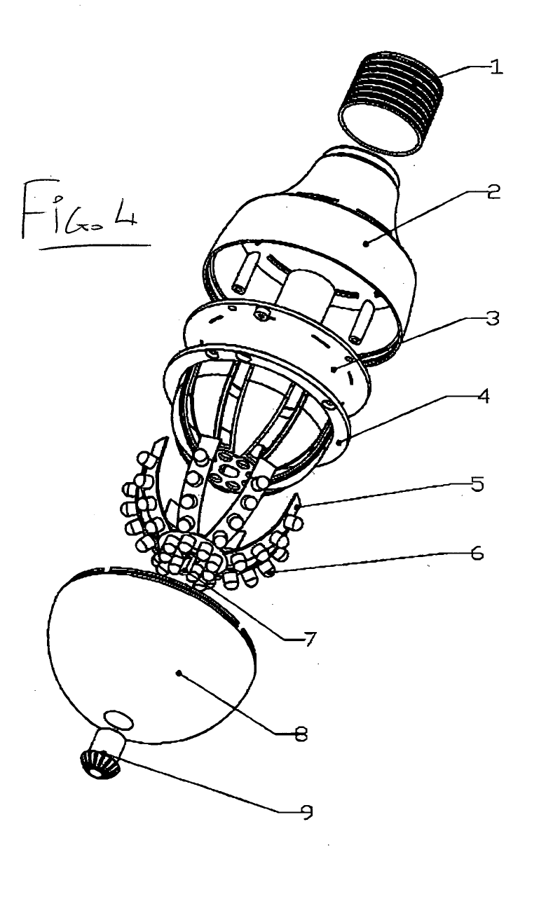

The structure of sample product 1 is showed in FIG. 1 to FIG. 4, from which can be seen that bulb shell consists of two parts, namely, the Lower Shell (7), which is made of a transparent material and Upper Shell (2), which is made either of the same material as the Lower Shell, or of an opaque material. The Upper Shell meets the screw base at one end and the two parts of shell together contain a round PCB (3), a frame (4), a star shaped PCB (5) which has a plurality of arms spreading from a center, and LEDs (6). The AD/DC converter is fixed on the round PCB (3), which converts the alternating current coming through the screw base to low voltage direct current which the LEDs work on. The frame (4) has eight curving arms arranged in a star shaped pattern, along the top curves of which the LEDs are distributed. The internal schematic view of the star shaped PCB (5) is shown in FIG. 4. When assembled, the arms of the star shaped PCB (5) are attached to the those of the frame (4) and are welded into the slots on the round PCB at the same time. The frame (4) and the round PCB (5) are fixed to the Upper Shell by screws. The Lower Shell is buckled tightly with the Upper Shell. It can be seen from FIG. 1 to FIG. 3 that the LEDs are virtually distributed across the surface of a hemisphere so that when the power is on, they light up a hemispheric illumination front. This design results in a more even brightness and a larger illumination area, making it more comfortable to the eye.

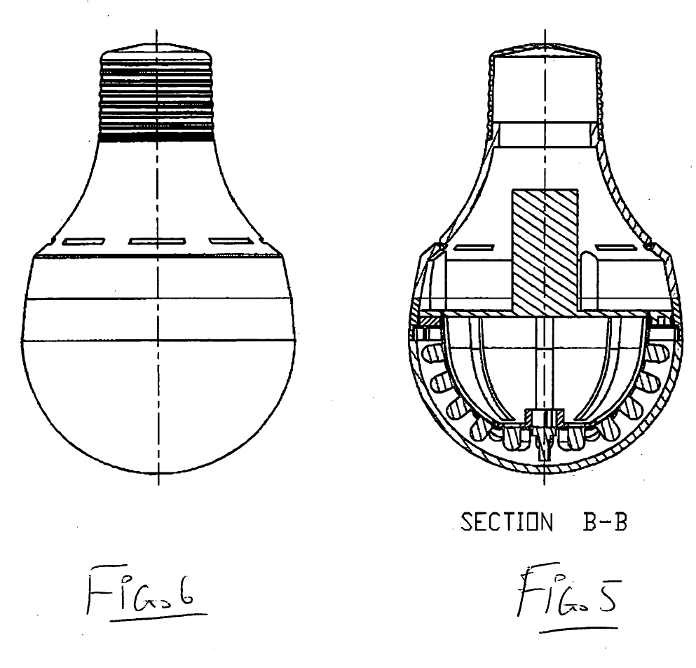

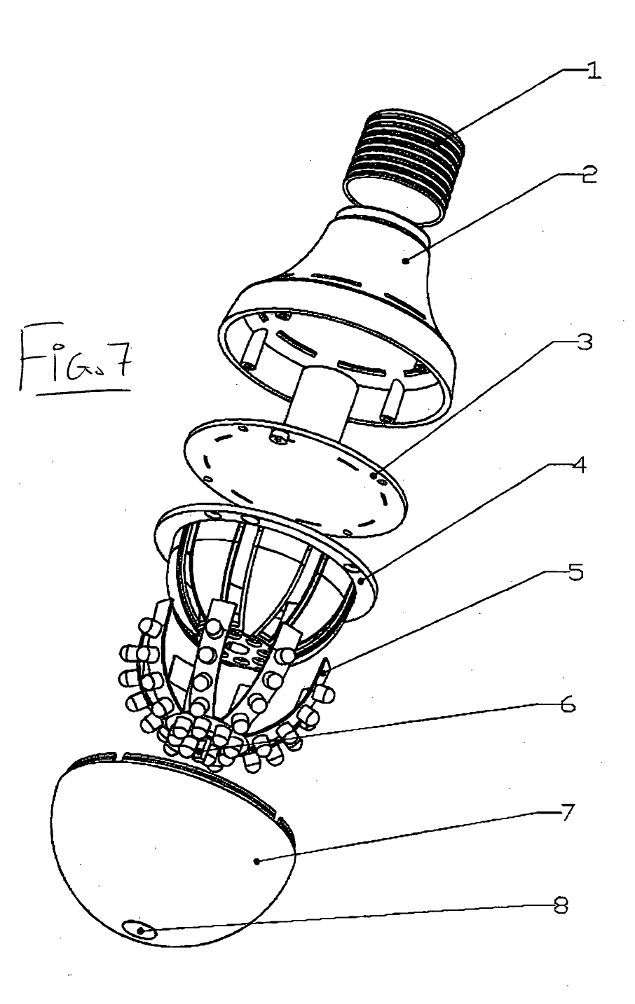

The structure of sample product 2 is showed in FIG. 5 to FIG. 7, with the only difference from that of sample product 1 being an additional electronic dimmer included in the shell. The dimmer is placed on the round PCB (3) as well and as is shown in the figure, its manual brightness modulating part is a turn knob (8) and the knob cap (9). Optional alternatives to the turn knob are a linear fader, a pair of digital up-and-down buttons, and a digital touch bar.

Both sample product 1 and sample product 2 are readily applicable to a standard lamp holder, as the one on a common family lamp originally for incandescent light bulbs.

A negative oxygen ion generator can also be added to the round PCB (3) on the basis of sample product 1 and 2. This generator generates negative oxygen ions good to health and to the environment. There is a switch to start and stop it.

On the other hand, it is also acceptable to remove the round PCB (3) integrated in sample product 1 and 2, together with the AD/DC converter and the electronic dimmer on it. The frame (4), the star shaped PCB (5) and the LEDs (6) stay put in the shell. With the absence of the AD/DC converter, it requires batteries or an external converter for power supply.

Furthermore, in practice the star shaped PCB (5) that facilitates the fixation of LEDs in the sample products can be replaced by other alternatives applicable to fixing the LEDs to the curving frame.

This innovative LED light bulb applies particularly to short distance illumination such as in the case of a desk lamp.

Alternatively, the AD/DC converter and the electronic dimmer can be placed outside the LED light bulb, for example, in the base of the lamp, with the brightness modulator setting on the top surface of the base.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An LED light bulb comprising:
a screw base;
a shell formed by two halves of hemispherical shells connecting tightly in the middle;
and a number of LEDs distributed spherical symmetrically on a curved flexible PCB inside an inner front of the shell;
the LEDs being series or parallel connected and arranged, when working, to emit light evenly in all directions.

2. The LED light bulb as claimed in claim 1 including a PCB which is fixed to a curved frame wherein all the LEDs are soldered symmetrically to the PCB.

3. The LED light bulb as claimed in claim 2 including an AD/DC converter inside the shell, which converts alternating current to direct current that the LEDs work on.

4. The LED light bulb as claimed in claim 1 including an electronic dimmer inside the shell to adjust light brightness.

5. The LED light bulb as claimed in claim 4 wherein the dimmer includes a manual brightness modulating part of the dimmer, which is set on the surface of the shell in the form of a turn knob, a linear fader, a pair of digital up-and-down buttons, or a digital touch bar.

6. The LED light bulb as claimed in claim 1 including a negative oxygen ion generator inside the shell, which produces and sends out negative oxygen ions through one or more small round openings on the surface of the shell.

7. A desk lamp comprising:
an LED light bulb comprising:
a screw base;
a shell formed by two halves of hemispherical shells connecting tightly in the middle;
and a number of LEDs distributed spherical symmetrically on a curved flexible PCB inside an inner front of the shell;
the LEDs being series or parallel connected and arranged, when working, to emit light evenly in all directions
a lamp fixture;
and a lamp holder, to which the LED light bulb is connected at its screw base.

8. The desk lamp as claimed in claim 7 including an AD/DC converter and an electronic dimmer inside the shell of the LED light bulb.

9. The desk lamp as claimed in claim 7 including a negative oxygen ion generator inside the shell of the LED light bulb.

10. The desk lamp as claimed in claim 7 including an AD/DC converter which converts alternating current to direct current that the LEDs work on.

11. The desk lamp as claimed in claim 10 wherein the converter is mounted inside the base of the lamp.

12. The desk lamp as claimed in claim 7 including an electronic dimmer which is mounted inside the base of the lamp.

13. The desk lamp as claimed in claim 12 wherein a manual brightness modulating part of the dimmer is set on the top surface of the base of the lamp.

14. The desk lamp as claimed in claim 13 wherein the manual brightness modulating part of the dimmer is in the form of a turn knob.

15. The desk lamp as claimed in claim 13 wherein the manual brightness modulating part of the dimmer is in the form a pair of digital up-and-down buttons,

16. The desk lamp as claimed in claim 13 wherein the manual brightness modulating part of the dimmer is in the form of a digital touch bar.

17. The desk lamp as claimed in claim 7 wherein the electronic dimmer includes a linear fader.
